(19) United States
(12) Patent Application Publication
(10) Pub. No.: US 2025/0104671 A1
(43) Pub. Date: Mar. 27, 2025

(54) REPETITION SPRING ASSEMBLY FOR AN UPRIGHT PIANO

(71) Applicant: LE JARDIN DES PIANOS, LOCATION DE PIANOS INC., Montreal (CA)

(72) Inventor: Oliver ESMONDE-WHITE, Montréal (CA)

(21) Appl. No.: 18/294,697

(22) PCT Filed: Aug. 4, 2022
(86) PCT No.: PCT/CA2022/051188

§ 371 Date: Feb. 2, 2024

Related U.S. Application Data
(60) Provisional application No. 63/203,950, filed on Aug. 5, 2021.
(60) Provisional application No. 63/267,416, filed on Feb. 1, 2022.

(51) Int. Cl. G10C 3/24; G10C 1/02; G10C 3/18

(52) U.S. Cl. CPC G10C 3/24; G10C 1/02; G10C 3/18

(57) ABSTRACT

A hammer return spring rail (10) for an upright piano including: at least one cavity (15) for receiving at least one rod (20): and a plurality of open compartments (25) each configured to receive a hammer return spring (30). each spring (30) including a coil (35). and each compartment (25) allowing the hammer return spring (30) to extend outward therefrom in a generally downward direction: each compartment (25) including a slot (45) for receiving an extension (40) of each hammer return spring (30); and each compartment including an aperture (50) for receiving an adjusting means (55) such that, by adjusting the degree to which the adjusting means (55) are inserted into the aperture (50). pressure applied to the extension (40) of the spring (30) can be increased or decreased. thereby causing an increase or decrease of the force exerted by the spring (30) on a corresponding hammer butt (60).

### FIELD OF THE INVENTION

The present invention relates to a hammer return spring rail for an upright piano, a modular hammer return spring rail for an upright piano, a repetition spring assembly for an upright piano, and a pedal assembly for an upright piano.

### BACKGROUND OF THE INVENTION

Fandrich vertical actions are modifications of traditional upright actions, as shown in U.S. Pat. No. 4,896,577 (FANDRICH) and in FIG. 1. In the technology of FANDRICH, the traditional jack spring is eliminated. Its function is assumed by a jack/repetition spring, which is a compression spring adjustably mounted between the jack near the end that engages the hammer butt and a pilot attached to the back stop portion of the hammer assembly. FANDRICH also discloses means for adjusting the value of the torque on the hammer produced by the force of the hammer return spring (which engages said hammer). FANDRICH states that, to make the return spring adjustable, it is mounted on a fulcrum on a spring rail and provided with an extension beyond the fulcrum. The extension fits in a slot in the rail and is engaged by a screw which is threaded into the rail, lies in the plane of the spring and has its turning axis essentially normal to the extension.

Modifications to the Fandrich Vertical Action have also been made over the years, such as that disclosed in U.S. Pat. No. 9,000,281 (FANDRICH) and shown in FIG. 2.

Furthermore, hammer return spring rails for uprights are generally a single integral piece of material, such as wood or plastic. Such hammer return spring rails must therefore be manufactured as a single piece of wood or plastic, which can prove complicated and cumbersome. In addition, as they are only a single piece of wood, the length of hammer return spring rails for uprights cannot be adjusted, nor can the distance between individual hammer return springs be adjusted. This means that if one wishes to alter the length of the hammer return spring rail or the distance between individual hammer return springs, one must make an entirely new hammer return spring rail.

U.S. Pat. No. 9,000,281 (FANDRICH) also discusses the incorporation of repetition springs for each piano key to address key return force during jack re-engagement in piano actions for vertical pianos. U.S. Pat. No. 9,000,281 (FANDRICH) states that repetition springs can come in various versions such as torsion springs or compression springs, and that one such example of repetition springs include the use of a compression spring adjustably mounted between a jack end and a pilot attached to a threaded shaft through a backstop portion extending from a hammer butt. As explained in U.S. Pat. No. 9,000,281 (FANDRICH), these efforts in using repetition springs sought in part to simulate in a general sense in these vertical piano actions how the force of gravity acts at least in part on components of actions found in grand pianos.

Pedal assemblies for upright pianos are also known. For example, pedal assemblies used with Fandrich Vertical Actions typically comprise a rotating bar hinged on the piano.

### SUMMARY OF THE INVENTION

In accordance with the present invention, there is provided:
1. A hammer return spring rail (10) for an upright piano, comprising:
   at least one cavity (15) extending along a length of the hammer return spring rail (10), said at least one cavity (15) configured to securely and removably receive at least one rod (20) so that the at least one rod (20) extends along the length of the hammer return spring rail (10); and
   a plurality of open compartments (25) each configured to receive a hammer return spring (30), each spring (30) being a torsion spring comprising a coil (35), and each compartment being configured such that, when the hammer return springs (30) are implemented into the hammer return spring rail (10), each spring coil (35) has a rod (20) passing therethrough;
   wherein each compartment (25) is sufficiently open so as to allow the hammer return spring (30) to extend outward therefrom in a generally downward direction;
   each compartment (25) comprises a slot (45) configured to receive an extension (40) of each hammer return spring (30); and
   each compartment comprises an aperture (50) at a top thereof, said aperture (50) being configured to receive an adjusting means (55) such that the adjusting means (55) lies in the plane of the extension (40), and such that, by adjusting the degree to which the adjusting means (55) are inserted into the aperture (50), pressure applied to the extension (40) of the spring (30) can be increased or decreased, thereby causing the spring (40) to pivot around the rod (20), which in turn increases or decreases the force exerted by the spring (30) on a corresponding hammer butt (60).
2. The hammer return spring rail (10) of item 1, wherein the at least one cavity (15) is one single continuous cavity extending along the length of the hammer return spring rail (10).
3. The hammer return spring rail (10) of item 1, wherein the at least one cavity (15) is a plurality of cavities extending along the length of the hammer return spring rail (10).
4. The hammer return spring rail (10) of any one of items 1 to 3, wherein each adjusting means (55) is a screw and each aperture (50) is threaded and sized to receive said screw (55).
5. The hammer return spring rail (10) of any one of items 1 to 4, wherein at least one tube-shaped structure (65), preferably a grommet or rubber tubing, is placed around each rod (20), such that each rod 20 is configured to be held in place inside its respective cavity (15) through the use of said tube-shaped structure (65).
6. The hammer return spring rail (10) of any one of items 1 to 5, wherein each extension (40) is enveloped in tubing (70), preferably heat-shrink tubing, more preferably 1.2 mm heat-shrink tubing.
7. The hammer return spring rail (10) of any one of items 1 to 6, wherein the hammer return spring rail (10) is made of wood.
8. The hammer return spring rail (10) of any one of items 1 to 6, wherein the hammer return spring rail (10) is made of plastic.
9. A kit for assembling a modular hammer return spring rail (110) for an upright piano comprising:
   a plurality of rail blocks (175) which are releasably connectable to each other to form at least a portion of an assembled modular hammer return spring rail (110), wherein at least one rail block (175) is configured to receive at least one hammer return spring (130).
10. The kit of item 9, wherein the rail blocks (175) are releasably connectable to each other using male and female connectors, preferably using male connectors (180) and female connectors (185) placed on the sides of the rail blocks (175), preferably such that rail blocks (175) can be releasably connected to each other by slidably connecting the male connector (180) of one rail block through the female connector (185) of another rail block.
11. The kit of item 9 or 10, wherein the rail blocks (175) can be secured to each other by slidably receiving a connecting rod (190), through an aperture (195), defined by the rail blocks (175).
12. The kit of item 11, wherein the aperture (195) has a hexagonally-shaped cross section for receiving a connecting rod (190) with a hexagonally-shaped cross section.
13. The kit of item 11 or 12, wherein each rail block (175) further comprises a screw hole (205) located on a back surface thereof that leads to the aperture (195), said screw hole being configured to receive a screw, such that, by tightening the screw until it abuts against the connecting rod (190), the rail block (175) can be secured in a specific position along the length of the connecting rod (190).
14. The kit of item 11 or 12, wherein a material, preferably a drop of silicone or contact cement, can be placed inside the aperture (195), such that the rail block (175) can be secured in a specific position along the length of the connecting rod (190) via friction.
15. The kit of any one of items 9 to 14, wherein the rail blocks (175) are releasably connectable to each other using an adhesive.
16. The kit of any one of items 9 to 15, wherein at least one rail block (175) is not configured to receive at least one hammer return spring (130).
17. The kit of any one of items 9 to 16, wherein each rail block (175) configured to receive at least one hammer return spring (130) is configured to receive a single hammer return spring (130).
18. The kit of any one of items 9 to 17, wherein the rail blocks (175) are the same or of varying width.
19. The kit of any one of items 9 to 18, wherein the rail blocks (175) configured to receive at least one hammer return spring (130) and/or the rail blocks (175) not configured to receive at least one hammer return spring (130) are the same or of varying width.
20. The kit of any one of items 9 to 19, wherein the rail blocks (175) are collectively configured to receive at least 88, preferably exactly 88, hammer return springs (130).
21. The kit of any one of items 9 to 20, wherein the rail blocks (175) are made of wood or plastic.
22. The kit of any one of items 9 to 21, wherein the rail blocks (175) are made of the same or different material.
23. The kit of any one of items 9 to 22, further comprising end blocks (210), each end block (210) being configured to allow the modular hammer return spring rail (110) to be installed into a piano, preferably through the use of apertures (215) defined by each end block (210).
24. The kit of any one of items 9 to 23, wherein the rail blocks (175) are configured to assemble into the hammer return spring rail as defined in any one of items 1 to 8.
25. An assembled modular hammer return spring rail (110) assembled from the kit as defined in any one of items 9 to 24.
26. A method of assembling the hammer return spring rail of item 25 using the kit as defined in item 23 or 24, comprising the steps of:
   inserting a rod through coils of a plurality of hammer return springs (130);
   for each hammer return spring (130), threading a rail block (175) configured to receive at least one hammer return spring (130) through the extension (140) until the coil (135) is received by the compartment (125), and until the rod (120) is securely and removably held in its corresponding cavity (115); and
   positioning the rail blocks along the rod to adjust the distance between each hammer return spring (130).
27. A repetition spring assembly (300) for an upright piano comprising:
   a repetition spring being a torsion spring (320) operatively coupled to a backstop portion (305) of a hammer assembly at a connection point (315) and operatively coupled to a jack end of a jack member, the torsion spring (320) extending therebetween;
   the backstop portion (305) comprising adjustment (310) means that can adjust the position of the connection point (315) along the backstop portion (305) so as to adjust the tension of the torsion spring (320).
28. The repetition spring assembly (300) of item 27, wherein the backstop portion (305) comprises a plate (350) that is connected to the adjustment means (310) and into which the torsion spring (320) can be inserted, preferably through an aperture (355), to connect the torsion spring (320) to the backstop portion (305).
29. The repetition spring assembly (300) of item 27 or 28, wherein the backstop portion (305) is oriented such that, when the hammer (330) is at rest, the adjustment means (310) is mostly horizontal to the ground and above a back check (345).
30. The repetition spring assembly (300) of item 27 or 28, wherein the backstop portion (305) is oriented such that the adjustment means (310) is mostly horizontal to the ground and above the back check (345) when a corresponding hammer (330) is resting against a corresponding string (360).
31. The repetition spring assembly (300) of any one of items 27 to 30, wherein the backstop portion (305) is oriented such that the adjustment means (310) is just above the back check (345), such that an adjustment tool (325) can rest atop the back check (345) while it is being used to adjust the tension in the torsion spring (320).
32. The repetition spring assembly (300) of item 31, wherein the top of the back check (345) comprises a groove dimensioned to receive the adjustment tool (325).
33. The repetition spring assembly (300) of any one of items 27 to 32, wherein at least a surface of the backstop portion (305) directly below where the connection point (315) is located is curved or slanted so as to reduce contact and friction between the torsion spring 320 and the backstop portion 305.
34. The repetition spring assembly (300) of any one of items 27 to 33, wherein the backstop portion (305) has an opening (405) (preferably conical in shape, preferably an opening of 3 mm or 2 mm in diameter) opposite the connection point (315) for insertion of a bushing.
35. The repetition spring assembly (300) of any one of items 27 to 34, wherein the backstop portion (305) comprises a catcher portion (365), a ring portion (370), and a shank portion (375), wherein the catcher portion (365) is operatively connected to the shank portion (375), the ring portion (370) is connected to the shank portion (375) in such a manner that it is movable along the length thereof, and the connection point (315) is located on the ring portion (370).
36. The repetition spring assembly (300) of item 35, wherein the adjustment means (310) (preferably a screw) is located at an upper portion of the catcher portion (365) of the backstop portion (305), such that by turning the adjustment means (310), the screw pushes the ring portion (370) (preferably at an upper portion of the ring portion (370)), thereby moving said ring portion (370) along a length of the shank portion (375).
37. The repetition spring assembly (300) of item 35 or 36, wherein the catcher portion (365) has a recess (380) (or an aperture) dimensioned to receive a corresponding protrusion from the shank portion (375).
38. The repetition spring assembly (300) of any one of items 35 to 37, wherein the catcher portion (365) further comprises a curved portion (400) on the bottom surface thereof in order to prevent the repetition from hitting it when the torsion spring is under its maximum tension.
39. The repetition spring assembly (300) of any one of items 35 to 38, wherein the ring portion (370) comprises an aperture (385) dimensioned to slidably receive a corresponding protrusion from the shank portion (375).
40. The repetition spring assembly (300) of any one of items 35 to 39, wherein the ring portion (370) has an ellipse-shaped cross section.
41. The repetition spring assembly (300) of item 40, wherein the minor axis of the ellipse-shaped cross section is horizontal with the ground and is around the width of the jack end of the jack member.
42. The repetition spring assembly (300) of any one of items 35 to 41, wherein, with respect to a vertical axis passing through the connection point (315), the angle of the line tangent to the curvature of the ring portion (370) (or rather the angle of the line tangent to the area of the backstop portion directly underneath the connection point (315)) with respect to said vertical axis is greater, preferably excessively greater, than the angle at which the torsion spring (320) (or any connector that connects the torsion spring (320) to the connection point (315)) approaches said connection point (315).
43. The repetition spring assembly (300) of any one of items 35 to 42, wherein the ring portion (370) is configured to be sufficiently secured to the shank portion (375) using the tension of the torsion spring (320) and the friction of the interaction between the ring portion (370) and the shank portion (375).
44. The repetition spring assembly (300) of any one of items 35 to 43, wherein the connection point (315) is located on a side of the ring portion (370),
45. The repetition spring assembly (300) of item 44, wherein the opening (405) is located opposite the connection point (315) on the ring portion (370).
46. The repetition spring assembly (300) of any one of items 35 to 45, wherein the shank portion (375) comprises a protrusion (390) dimensioned to be slidably received by the aperture (385) of the ring portion (370) and recess (380) of the catcher portion (365).
47. The repetition spring assembly (300) of item 46, wherein the protrusion (390) defines an aperture (395).
48. The repetition spring assembly (300) of any one of items 35 to 47, wherein the catcher portion (365) and the shank portion (375) are one integral part.
49. The repetition spring assembly (300) of any one of items 35 to 48, wherein the shank portion (375) further comprises a female connector (410) configured to receive a corresponding male connector of a corresponding hammer butt.
50. The repetition spring assembly (300) of any one of items 35 to 48, wherein the shank portion 375 further comprises a male connector (415) configured to be received by a female connector of a corresponding hammer butt.
51. The backstop portion (305) as defined in any one of items 27 to 50.
52. A pedal system for an upright piano, said pedal system comprising a soft pedal and a free floating bar (4) configured to lift back ends of piano keys when the pedal is pressed, thereby bringing corresponding hammers closer to corresponding strings.
53. The pedal system of item 52, wherein the soft pedal is configured to pull a pedal rod (2) downwards when pressed, said pedal rod (2) being configured to pull one end of each of a left lever (1) and a right lever (3) downwards when the pedal is pressed, which causes each of the left lever (1) and the right lever (3) to rotate around a corresponding center of rotation (8), thereby lifting pushing rods (9) operatively connected to the other end of each of the left lever (1) and the right lever (3), said pushing rods (9) configured, when raised upward, to lift the free floating bar (4) placed under the back ends of piano keys, such that, overall, pressing the pedal causes the free floating bar (4) to be lifted sufficiently upward to raise the back ends of the piano keys.
54. The pedal system of item 53, further comprising adjustment means (10) (preferably a screw type capstan) for adjusting the height of the pushing rods (9), such that the height at which the free floating bar (4) is lifted by each of the pushing rods (9) when the pedal is pressed is adjustable.
55. The pedal system of any one of items 52 to 54, configured for use with the repetition spring assembly (300) as defined in any one of items 27-50.
56. The pedal system of any one of items 52 to 54, configured for use with the assembled modular hammer return spring rail (110) as defined in item 25.
57. The pedal system of any one of items 52 to 54, configured for use with the hammer return spring rail as defined in any one of items 1 to 8.
58. A hammer return spring rail (510) for an upright piano, comprising:
   a rod (520) extending along a length of the hammer return spring rail (510);
   a plurality of leaf springs (530), each leaf spring (530) having a first section that is securely and removably received by the rod (520) and a second section that is configured to exert a force on a corresponding hammer butt (60);
   wherein the first section of the leaf spring (530) is configured to receive adjusting means (550,555) and such that, by adjusting a degree to which the adjusting means (550, 555) are inserted onto the first section of the leaf spring (530), pressure applied to the first section of the leaf spring (530) can be increased or decreased, thereby causing a second section of the leaf spring (530) to pivot around the rod (520), which in turn increases or decreases the force exerted by the leaf spring (530) on the corresponding hammer butt (60).
59. The hammer return spring rail (510) of item 58, wherein the adjusting means comprise a screw (555) and a lock nut (550) cooperating with the screw (550).
60. The hammer return spring rail (510) of item 59, wherein the first section of the leaf spring (530) is configured to be coiled around the rod (520), the first section of the leaf spring (530) has a first passage (560) and a second passage (565) configured to be aligned with the first passage (560) and for receiving the screw (555), whereby a tension of the leaf spring (530) is adjusted by screwing the lock nut (550).
61. The hammer return spring rail (510) of any one of items 58-60, wherein the rod (520) has a hexagonal shape.

### BRIEF DESCRIPTION OF THE DRAWINGS

FIG. 1 is a schematic partially sectioned diagram of a conventional Fandrich Vertical Action.

FIG. 2 is a side elevation view of portions of a conventional modified Fandrich Vertical Action.

FIG. 3 is a front view of a portion of a hammer return spring rail according to an embodiment of the present invention.

FIG. 4 is a front isometric view of a portion of the hammer return spring rail of FIG. 3.

FIG. 5 is a back view of a portion of the hammer return spring rail of FIG. 3.

FIG. 6 is back isometric view of a portion of the hammer return spring rail of FIG. 3.

FIG. 7 is a back isometric view of a portion of the hammer return spring rail of FIG. 3, with screws and springs being removed.

FIG. 8 is an isometric view of a vertical action comprising a portion of a hammer return spring rail according to an embodiment of the present invention.

FIG. 9 is a front view of the vertical action of FIG. 8.

FIG. 10 is a side view of the vertical action of FIG. 8.

FIG. 11 is a front view of a portion of another modular hammer return spring rail according to an embodiment of the present invention, in a partially assembled form.

FIG. 12 is a front isometric view of the portion of the modular hammer return spring rail of FIG. 11.

FIG. 13 is a rear view of a portion of the modular hammer return spring rail of FIG. 11.

FIG. 14 is a rear isometric view of a portion of the modular hammer return spring rail of FIG. 19.

FIGS. 15-17 are side views of a vertical action comprising a repetition spring assembly according to an embodiment of the present invention.

FIGS. 18-19 are side views of a vertical action comprising a repetition spring assembly according to another embodiment of the present invention.

FIG. 20 is a front view of a portion of a modular hammer return spring rail according to an embodiment of the present invention, in a partially assembled form.

FIG. 21 is an isometric view of a portion of the modular hammer return spring rail of FIG. 20.

FIG. 22 is a rear view of a portion of the modular hammer return spring rail of FIG. 20.

FIG. 23 is an isometric rear view of a portion of the modular hammer return spring rail of FIG. 20

FIG. 24 is an isometric view of a rail block of the modular hammer return spring rail of FIG. 20.

FIG. 25 is a front view of the rail block of FIG. 24.

FIG. 26 is a cross-sectional view of the rail block of FIG. 25, across lines D-D.

FIG. 27 back view of the rail block of FIG. 24.

FIG. 28 is an isometric view of a backstop portion of the repetition spring assembly according to another embodiment of the present invention.

FIG. 29 is a ride side view of the repetition spring assembly of FIG. 28.

FIG. 30 is a front view of the repetition spring assembly of FIG. 28.

FIG. 31 is a left side view of the repetition spring assembly of FIG. 28.

FIGS. 32-35 are an isometric view, a front view, a left side view, and a back view, respectively, of the catcher portion of the backstop portion of the repetition spring assembly of FIG. 28.

FIGS. 36-39 are an isometric view, back view, a cross-sectional view across lines A-A, and a front view, respectively, of the ring portion of the backstop portion of the repetition spring assembly of FIG. 28.

FIGS. 40-43 show an isometric view, a side view, a front view, and a top view, respectively, of the shank portion of the backstop portion of the repetition spring assembly of FIG. 28.

FIGS. 44-45 are an isometric view and side view of a backstop portion of the repetition spring assembly according to another embodiment of the present invention.

FIGS. 46-48 are an isometric view, a left side view, and a front view, respectively, of the shank portion of the backstop portion of the repetition spring assembly of FIGS. 44-45.

FIG. 49 is an isometric view of a backstop portion of the repetition spring assembly according to another embodiment of the present invention.

FIGS. 50-54 are a front view, left side view, a right side view, an isometric top view and bottom isometric vie respectively, of a portion of a pedal assembly according to an embodiment of the present invention, for installation in an upright piano.

FIG. 55 is an isometric view of a hammer return leaf spring rail according to another embodiment of the present invention.

FIG. 56 is an isometric view of a return leaf spring of the hammer return leaf spring rail of FIG. 55.

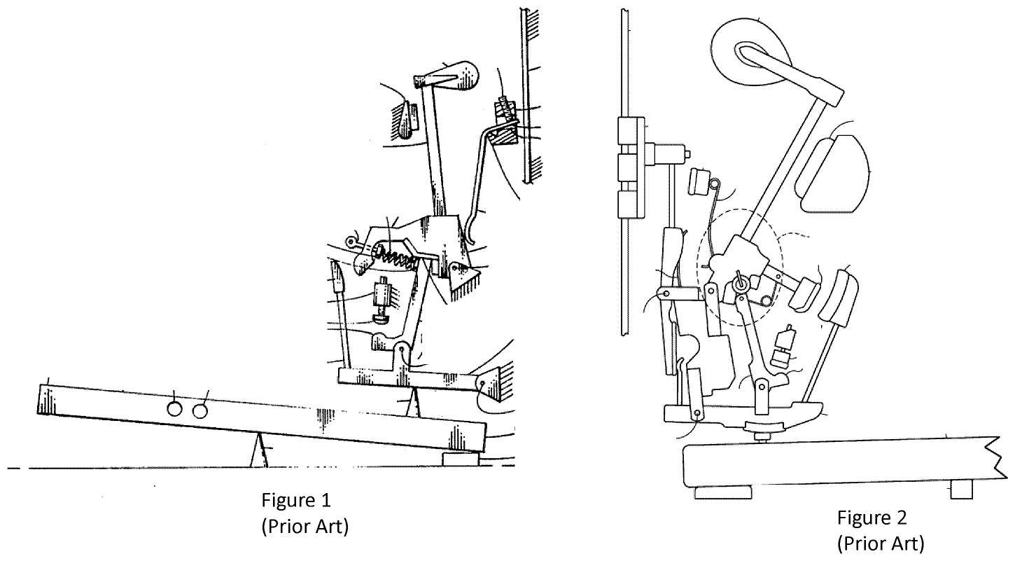

### DETAILED DESCRIPTION OF THE ILLUSTRATIVE EMBODIMENTS

### Hammer Return Spring Rail

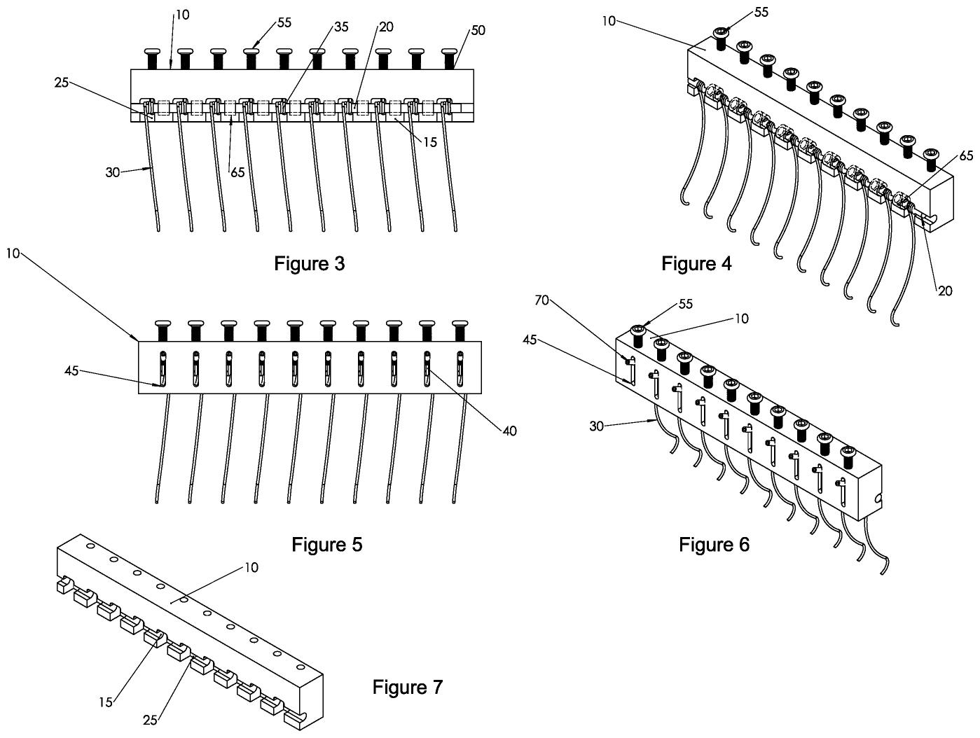

Referring first to FIG. 3, as well as FIGS. 4-7, a hammer return spring rail, generally referred to using the reference numeral 10, will be described. As shown for example in FIG. 3, the hammer return spring rail 10 comprises at least one cavity 15 extending along a length of the hammer return spring rail 10, said at least one cavity 15 configured to securely and removably receive at least one rod 20 so that the at least one rod 20 extends along the length of the hammer return spring rail 10. Furthermore, the hammer return spring rail 10 comprises a plurality of open compartments 25 each configured to receive a hammer return spring 30. Each spring 30 is a torsion spring that includes a coil 35, and each compartment is configured such that, when the hammer return springs 30 are implemented into the hammer return spring rail 10, each spring coil 35 has a rod 20 passing through it.

As shown in FIG. 3, each compartment 25 is sufficiently open so as to allow the hammer return spring to extend outward therefrom in a generally downward direction, thereby allowing the spring 30 to engage a corresponding hammer butt 60 (as shown for example in FIG. 12). Moreover, each compartment 25 comprises a slot 45 configured to receive an extension 40 of each hammer return spring 30. Furthermore, as shown in FIG. 3, each compartment comprises an aperture 50 at a top thereof, said aperture 50 being threaded and sized to receive a screw 55. The screw 55 must lie in the plane of the corresponding extension 40, and it must be sufficiently long so that it can abut and apply pressure to said extension 40 when inserted into the aperture 50. The purpose of the screw 55 is that, by turning the screw, pressure (or rather, the force) applied to the extension 40 of the spring 30 can be increased or decreased. This causes the spring 40 to pivot around the rod 20, which in turn increases or decreases the force exerted by the spring 30 on the corresponding hammer butt 60 and vice versa. The person of skill in the art would understand that while it is preferable that the aperture 50 be threaded so as to receive screws 55, the aperture 50 can also be configured and sized to receive any suitable adjusting means, such as levers, cams, or hand screws. What is important is that the adjusting means can be easily accessed by a user who wishes to adjust the tension in a given hammer return spring 30 in the manner described above, specifically by increasing or decreasing the force applied to the extension 40.

Each cavity 15 should be dimensioned so as to securely and removably receive its corresponding rod 20. In preferred embodiments, and as shown for example in FIG. 3, each cavity 15 is dimensioned so as to be slightly wider than the diameter of the corresponding rod 20, and such that each rod 20 can be held in place inside its respective cavity 15 through the use of a tube-shaped structure 65, such as a grommet (as seen in FIG. 3 and FIG. 4, for example) or rubber tubing. Naturally, if tube-shaped structures 65 are used, each cavity 15 should be dimensioned so as to securely and removably receive its corresponding tube-shaped structure 65. Each tube-shaped structure 65 can also function as a spacing element between springs 30.

In preferred embodiments, such as that shown for example in FIG. 3, the at least one rod 20 is a metal rod (more preferably a ⅛-inch steel rod, as shown for example in FIG. 3). In preferred embodiments, said metal rod is held in place with rubber tubing that is 2.5 to 3 mm wide. However, the skilled person would understand that the at least one rod 20 could be made of a variety of sufficiently durable and rigid materials, such as carbon fiber, plastic, or brass.

As shown for example in FIG. 3, each compartment 25 should be sufficiently sized to house the coil 35 of its corresponding spring 30, while leaving enough space such that the spring 30 is not hindered from pivoting around its corresponding rod 20 due to friction between the coil 35 and the hammer return spring rail 10.

In addition, the diameter of each coil 35 should be slightly larger than the diameter of the corresponding rod 20, but sufficiently small so that its rotation about the rod 20 is not hindered by the walls of its corresponding compartment 25 when installed in the hammer return spring rail 10. In preferred embodiments, the coil 35 does not come into contact with the walls of its corresponding compartment 25 when installed in the hammer return spring rail 10. This will help reduce unnecessary friction between the spring and the hammer return spring rail 10 when the tension of the former is being adjusted, which will help prevent damage to both the springs 30 and the components of the hammer return spring rail 10.

Similarly, the rest of the spring 30 should be shaped and dimensioned so as to minimize contact with the walls of its corresponding compartment 25, as contact with said walls will increase the friction caused during the rotation of the spring 30, which may cause stress to the spring 30 or the hammer return spring rail 10.

Each slot 45 should be wide enough to prevent friction between the extension 40 extending therethrough, but narrow enough so as to prevent the extension 40 from moving from side to side (since this may result in the extension 40 moving so much that it is no longer in the path of the screw 55). Further, each slot 45 should be high enough to allow its respective spring 30 to rotate as much as possible around its corresponding rod 20 (as rotating the spring 30 causes the extension 40 to move up and down the height of the slots 45). It is understood that, the higher the slot 45, the more the spring 30 can rotate around the rod 20, meaning the more the tension in the spring 30 can be adjusted using the screw 55.

In preferred embodiments, and as shown for example in FIG. 5, the slot 45 extends from the back of its corresponding compartment 25 all the way through the hammer return spring rail 10 to the back surface thereof. In such embodiments, each extension 40 can be long enough to extend out from its corresponding slot 45 at the back of the hammer return spring rail 10, as shown for example in FIG. 5. However, each extension 40 does not necessarily need to be long enough to extend out from its corresponding slot 45 at the back of the hammer return spring rail 10. In embodiments where the extension 40 does not extend out from its corresponding slot 45, the slot 45 does not need to extend through the entire rail (meaning the back surface of the rail can be “closed”); what matters is that each slot extends far enough through the hammer return spring rail 10 so as to receive its corresponding extension 40.

In preferred embodiments, and as shown for example in FIG. 5, each extension 40 is enveloped in tubing 70, preferably heat-shrink tubing, more preferably 1.2 mm heat-shrink tubing. The use of such tubing 70 prevents unwanted interactions between the extension 40 and its corresponding screw 55 or other adjusting means. Enveloping the extension 40 in tubing is especially preferable when the hammer return spring rail 10 is made of wood, as it prevents unwanted interference between the extension 40 and the walls of the corresponding slot 45.

In preferred embodiments, such as those shown for example in FIG. 3, the cavity 15 is one continuous cavity extending along the entire length of the hammer return spring rail 10. Similarly, in preferred embodiments, the rod 20 is one continuous rod that extends along the entire length of the cavity 15. In alternative embodiments, the hammer return spring rail 10 comprises a series of cavities 15 and/or rods 20 that extend along the length of the hammer return spring rail 10 in series. The skilled person would understand that different configurations are possible; what matters is that every hammer return spring 30 has a rod 20 passing through its coil 35. For clarity, if the hammer return spring rail 10 comprises a sequence of noncontinuous cavities 15, it necessarily must comprise a series of rods 20. However, if the hammer return spring rail 10 comprises one single continuous cavity 15, it may still comprise a series of rods 20 placed along the length of the cavity 15 in a continuous or noncontinuous manner. In embodiments configured to receive multiple rods 20, it may be easier to replace individual hammer return springs 30, as a user would only need to remove the rod 20 corresponding to a given spring 30. In theory, there could be, for example, a different rod 20 for every hammer return spring 30, or, for example, a different rod for every 5-10 hammer return springs 30. However, by having a greater number of rods 20 and/or cavities 15, the hammer return spring rail 10 may be more difficult or complicated to manufacture and/or maintain, due to the increased number of components. The lengths of rods used can be varied according to the preferences of the manufacturer and the user.

The hammer return spring rail 10 of the present invention can be made of any material known in the art for the use of hammer return spring rails, such as wood and polymer plastics. In preferred embodiments, such as that shown for example in FIG. 3, the hammer return spring rail is made of wood.

In embodiments, in addition to the advantages previously discussed, the hammer return spring rail 10 of the present invention may present one or more of the following advantages:

The tension in the hammer return springs 30 of the hammer return spring rail 10 of the present invention is easily adjusted using the screws 55 which are easily accessibly on the top of the hammer return spring rail 10 (as opposed to needing to be adjusted by hand, which is a very difficult process).

The at least one rod 20 passes through the center of each spring's coil 35, and the springs 30 pivot around their corresponding rod 20 when the tension thereof is adjusted. As a rod 20 is used as a “pivot point” around which each spring 30 pivots, the springs 30 are less likely to undergo undue stress, bend unnecessarily, or get damaged as easily when they are being adjusted.

Minimized friction and/or unwanted interactions between the spring 30 (including the extension 40) and the hammer return spring rail 10 (including the slot 45).

Minimized unwanted interactions between the screws 55 and the spring extensions 40, when said extensions are enveloped in tubing 70.

The hammer return spring rail 10 of the present invention may be much easier to manufacture than conventional hammer return spring rails.

Furthermore, the at least one rod 20 is easy to install and remove, which makes it easier to maintain the hammer return spring rail 10, and makes it easier to add, remove, or replace springs 30, when necessary.

The return spring 30 used in the hammer return spring rail 10 of the present invention preferably does not comprise the 90-degree “kink” present in conventional Fandrich vertical piano actions. In conventional Fandrich Vertical Actions, such a kink was used to help secure the tail of the spring in a slot in the rail, where it helped immobilize the tail and where all tension adjustments had to be made by manually distorting the spring. As the spring 30 used in the hammer return spring rail 10 of the present invention can be adjusted using screws 55 or other adjusting means which are easily accessibly on the top of the hammer return spring rail 10, this “kink” is no longer necessary.

With the hammer return spring rail 10 of the present invention, the tension of hammer return springs 30 can be easily adjusted. For example, and in preferred embodiments, hammer return springs 25 are variable from about 40 to 70 grams of down-weight in the keyboard, to within 1 gram of tolerance, within a matter of seconds.

The spring rail of the present invention has important advantages for bio-mechanical research projects as the parameters of up-weight and down-weight can be altered without significant impact to other parameters. The adjustments can also be configured to be regulated by robotic means.

### Modular Hammer Return Spring Rail for an Upright Piano

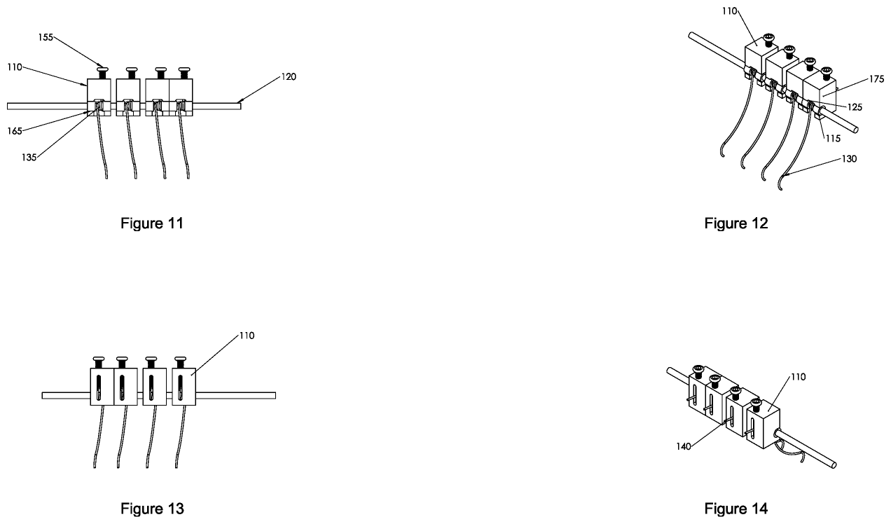

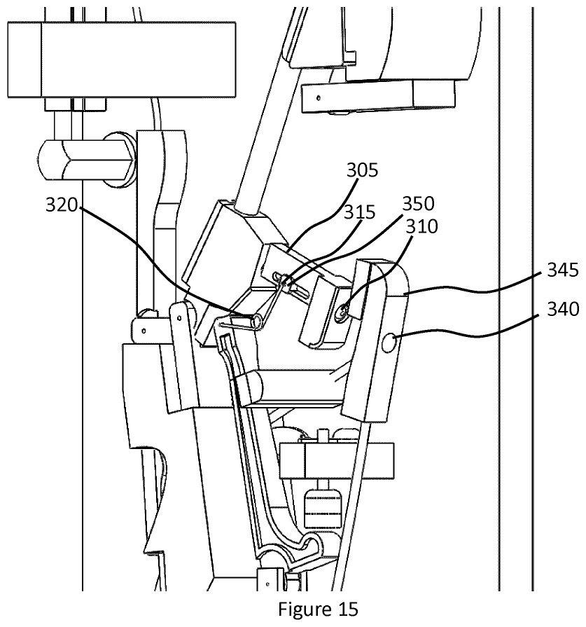

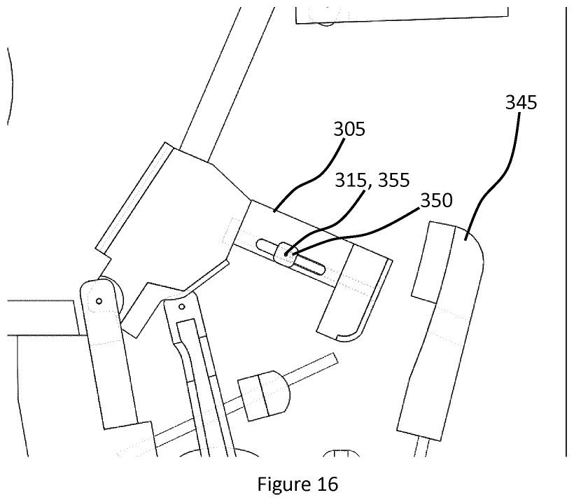

In a second aspect of the present invention, a modular hammer return spring rail for an upright piano is provided. Referring first to FIGS. 11-14, said modular hammer return spring rail, generally referred to using the reference numeral 110, will be described.

As shown in FIG. 12, the modular hammer return spring rail 110 comprises a plurality of rail blocks 175 which can be connected to each other to form an assembled modular hammer return spring rail 110. Specifically, the rail blocks 175 are removably connectable to each other and, when a series of rail blocks 175 are connected together, the assembled modular hammer return spring rail 110 is formed.

In FIG. 12, the rail blocks 175 may be connected to each other using male connectors and female connectors placed on the sides of the rail blocks, such that rail blocks can be releasably connected to each other by slidably connecting the male connector of one rail block through the female connector of another rail block. Once connected in such a manner, the rail blocks can be further secured to each other by slidably receiving a connecting rod 120 through an aperture defined by the rail blocks. This will better secure the rail blocks 175 to each other.

However, the person of skill in the art would understand that the rail blocks 175 could be constructed so as to removably connect to each other in a variety of manners. What matters is that the rail blocks are easily connectable to teach other and, in preferred embodiments, easily removable from each other so that the desired assembled modular hammer return spring rail 110 can be assembled and, in preferred embodiments, disassembled rather easily. For example, similar to the slidable connectors discussed above, the right side of each rail block 175 could comprise a male projection (not shown) configured to be received by a female connector (not shown) on the left side of another rail block 175. Alternatively, the left side of each rail block could comprise a male stud connector configured to be slidably received by a corresponding female connector on the right side of another rail block 175. Many other configurations are available, as would be understood by the person of skill in the art.

In embodiments, an adhesive can be used to connect the rail blocks 175 together, although this may make it more difficult to disconnect the rail blocks 175 from each other in the event that disassembly is required.

As the rail blocks are meant to assemble into a modular hammer return spring rail 110, the modular hammer return spring rail 110 comprises rail blocks configured to receive at least one hammer return spring 130, as shown in FIGS. 11-14. These rail blocks will be referred to as “spring rail blocks”.

In embodiments, all rail blocks are configured to receive at least one hammer return spring 130, meaning all rail blocks 175 are spring rail blocks.

In embodiments, rail blocks 175 can be designed such that, when connected to another rail block, the two adjacent rail blocks 175 together are configured to receive a hammer return spring. For example, each rail block can define a “half-compartment” on either side thereof, such that when the rail block is connected to another rail block, said other rail block also defining a “half-compartment” on either side thereof, one “half-compartment” of one rail block will be adjacent a “half compartment” of the other rail block, thus forming one compartment configured to receive a hammer return spring.

In alternative and preferred embodiments, the modular hammer return spring rail 110 further comprises rail blocks 175 that are not configured to receive hammer return springs; such rail blocks will be referred to as “spacer rail blocks”. Their function is to allow a user to adjust the distance between spring rail blocks, thereby adjusting the distance between the hammer return springs 130 once the modular hammer return spring rail 110 is assembled. This is because, in an upright piano, the space between each hammer is not uniform, meaning the space between each hammer return spring is not uniform. In order to account for these variable distances, a user can adjust the distances between spring rail blocks using spacer rail blocks when assembling the modular hammer return spring rail 110. For example, if the user wishes for two hammer return springs to be close together, they may choose to place two spring rail blocks together, with no spacer rail blocks in between. Conversely, if the user wishes to increase the distance between two hammer return springs, they can simply insert spacer rail blocks between two spring rail blocks until the desired distance is achieved. In more preferred embodiments, the spacer rail blocks are considerably thinner than the spring rail blocks, as this allows for greater adjustability.

The width of each rail block can vary. In embodiments, each spring rail block is of the same width. In alternative embodiments, different spring rail blocks may have different widths. In such a configuration, it may not be necessary to user spacer rail blocks, as one could simply use a wider spring rail block in order to increase the distance between two hammer return springs 130. For clarity, once assembled, the combined widths of the connected rail blocks 175 correspond to the length of the modular hammer return spring rail 110. In embodiments, the spacer rail blocks may be of the same or of varying width, as well.

As mentioned, in preferred embodiments, each spring rail block is configured to receive a single hammer return spring. However, spring rail blocks may be configured to receive multiple hammer return springs. For example, a single spring rail block can be configured to receive 5 or 10 hammer return springs. Naturally, spring rail blocks configured to receive a higher number of hammer return springs will need to be wider in order to be able to accommodate said increased number of springs. Also, it would be understood that while using spring rail blocks configured to receive a higher number of hammer return springs may make the modular hammer return spring rail 110 simpler to assemble (as fewer spring rail blocks will need to be assembled together), the adjustability of said modular hammer return spring rail 110 is decreased, as the user would not be able to adjust the distance between hammer return springs on the same spring rail block.

Once assembled, the modular hammer return spring rail 110 of the present invention can be about 4 feet long, as this is the general length of most conventional hammer return spring rails. However, different actions may require slightly different rail lengths; one advantage of the modular hammer return spring rail 110 of the present invention is that its length can be easily adjusted by adding or removing spacer blocks, or by using wider or narrower spring rail blocks. With conventional hammer return spring rails, the hammer return spring rail must be assembled in its entirety with the correct length and with correct spacing for the hammer return springs, and a user cannot adjust the length of the hammer return spring rail or the distance between hammer return springs (the user would have to manufacture an entirely new hammer return spring rail).

In preferred embodiments, such as that shown in FIGS. 11-14, the modular hammer return spring rail 110, once assembled, is a hammer return spring rail as defined in the previous section. In such a preferred embodiment, spring rail blocks would comprise at least one compartment 125 as defined in the previous section, each compartment configured to receive a hammer return spring 130 as defined in the previous section. Once assembled, the modular hammer return spring rail 110 would comprise at least one cavity 115 extending along a length of the hammer return spring rail 110, said at least one cavity 115 being configured to receive at least one rod 120 extending along the length of the hammer return spring rail 110, the at least one cavity and the at least one rod 120 being as defined in the previous section. This means that, in embodiments, each spring rail block and each spacer rail block may comprise a cavity such that, once assembled, the modular hammer return spring rail 110 comprises a single continuous cavity 115 extending along the length thereof. Alternatively, the spring rail blocks and spacer rail blocks may be configured such that, once assembled, the modular hammer return spring rail 110 comprises a plurality of cavities 115 extending along the length thereof.

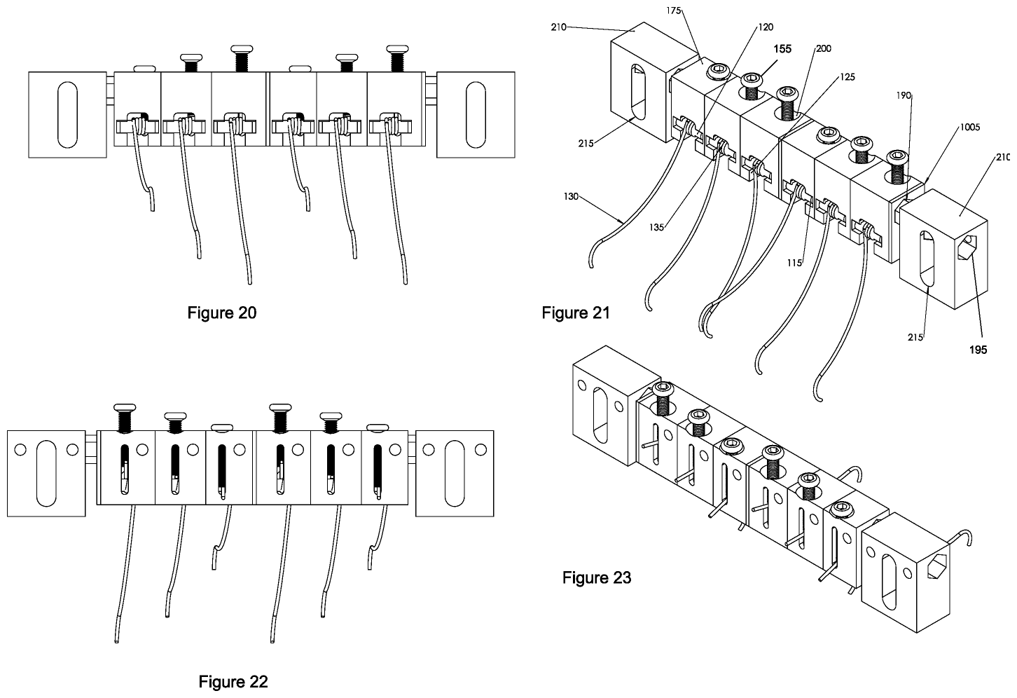

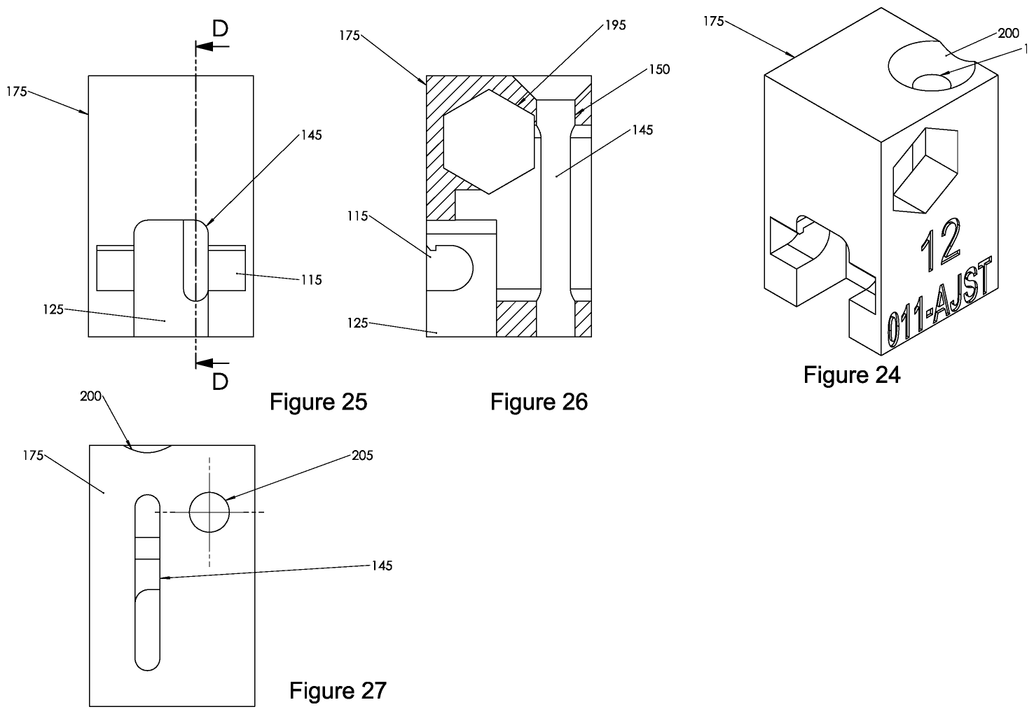

As with the hammer return spring rail defined in the previous section, what matters is that, once assembled, each hammer return spring 130 has a corresponding cavity 115 configured to removably receive its corresponding rod 120. This is because the coil 135 of each hammer return spring 130 will have a rod 120 passing therethrough. As shown in FIGS. 20-23, each rod 120 may be held in place with a tube-shaped structure 65 (shown in FIG. 3) as defined in the previous section. In embodiments of the modular hammer return spring rail 110, the rail blocks 175 are connectable to each other through the at least one rod 120, specifically by having each rail block 175 securely and removably connectable to the same rod 120. Naturally, with such embodiments, this means that the rail blocks 175 need to be sufficiently securely connected to the rod 120 such that they do not rotate or slide along the rod 120 during use of the hammer return spring rail 110.

Similarly, the compartment 125 of the spring rail blocks can comprise a slot, an aperture, and a screw 155 (or any other adjustment means) as defined in the previous section, and the springs used can be torsion springs including an extension 140 and tubing as defined in the previous section. This means that the assembled modular hammer return spring rail 110 allows for easy adjustment of the hammer return spring tension using screws, as explained in the previous section.

In preferred embodiments, the modular hammer return spring rail 110 shown in FIGS. 11-14 can be assembled by inserting a rod through the coils of various springs 130 (the number of which will depend on the needs of the user). Once that is done, each spring rail block can be “threaded” through the extension 140 until the coil 135 is received by the compartment 125, and until the rod 120 is securely and removably held in its corresponding cavity 115. Once a sufficient number of spring rail blocks have been added to the rod 120, the spring rail blocks can be positioned along the rod 120 to adjust the distance between each spring 130.

The rail blocks 175 of the modular hammer return spring rail 110 can be made of any material known in the art for the use of hammer return spring rails, such as wood and polymer plastics. In preferred embodiments, such as that shown for example in FIGS. 11-14, the rail blocks 175, and therefore the resulting modular hammer return spring rail 110, are made of plastic. It should be noted that when the rail blocks 175 are made of wood, the resulting modular hammer return spring rail 110 may require brackets to hold up the rail and keep it stiff, as might be necessary with a conventional wooden hammer return spring rail. However, when plastic is used, such brackets may not be necessary. In embodiments, all rail blocks 175 can be made of the same or different material, as long as they can be removably connected to each other.

The rail blocks used to assemble the modular hammer return spring rail 110 can be packaged as an unassembled kit. The number of rail blocks may vary, but in preferred embodiments, there are a sufficient number of rail blocks to assemble an entire modular hammer return spring rail 110 (this would mean enough spring rail blocks to hold 88 springs for the 88 hammers of the piano). However, smaller kits comprising fewer rail blocks 175 can be sold, for example as replacement or repair kits.

The rail blocks 175 can me manufactured in a variety of ways, as would be understood by the person of skill in the art, such as with CNC (wood), injection moulding (plastic), or 3D printing. In preferred embodiments, the rail blocks 175, including the connecting rod 190, are made of nylon, carbon fiber, Kevlar, PC (polycarbonate), PETG (Polyethylene Glycol), and/or brass, more preferably glass fiber nylon.

A preferred embodiment of the modular hammer return spring rail 110 is shown in FIGS. 20-23. In said embodiment, the aperture 195 has a hexagonally-shaped cross section for receiving a connecting rod 190 with a hexagonally-shaped cross section. By having such a shape, the rail blocks 175 will be prevented from rotating around the connecting rod 190, while also ensuring that the connecting rod 190 is easy to manufacture and is sufficiently strong for use in the modular hammer return spring rail 110. In addition, as shown in FIG. 48, the aperture 150 defined by the top surface of the rail block 175 is located in a slightly recessed portion 200 of said top surface of the rail block 175; this recessed portion 200 makes it easier to insert screws (or other adjustment means) into the aperture 150, as inserting the screw into the recessed portion 200 of the top surface will cause the screw to be directed to the aperture 150.

As shown in FIG. 21, the rail block 175 preferably further comprises a screw hole 200 located on the back surface thereof that leads to the aperture 195. By having such a screw hole 200, a screw 155 can be inserted therein, and by tightening the screw until it abuts against the connecting rod 190, the rail block 175 can be secured in a specific position along the length of the connecting rod 190. Alternatively, and preferably, a material, such as a drop of silicone or contact cement, can be placed on the connecting rod 190 in order to prevent the rail block 175 from sliding. This way, the rail block 175, or groups of rail blocks 175, can be secured in a specific position along the length of the connecting rod 190 (e.g. by having a group of rail blocks 175 be sandwiched between two drops of silicone or contact cement).

In addition, in preferred embodiments, the rail block 175 comprises a dampening material (not shown), more preferably felt, or a bead or line of silicone, on the back surface thereof to eliminate noise from the damper assembly hitting the hammer return spring rail 110.

As shown in FIG. 21, in preferred embodiments, the modular hammer return spring rail 110 further comprises end blocks 210. Each end block 210 is configured to allow the modular hammer return spring rail 110 to be installed into a piano. Preferably, this is achieved through the use of apertures 215, as shown in FIG. 21. Screws that are conventionally used to hold conventional hammer rest rails in place can be used to fix the hammer return spring rail 110 to the action brackets of the piano. The apertures 215 are slots that can receive such screws. Said apertures 215 can allow for adjustments of the height of the hammer return spring rail 110, but are mainly used to hold the hammer return spring rail 110 in its desired position. The height of the hammer return spring rail 110 changes how much resistance occurs while the key is being played. Accordingly, adjusting the height of the hammer return spring rail 110 allows it to be adapted for players who would require a specific type of resistance of the keyboard. Similarly, adjusting the height can reduce the severity of the change in resistance while pressing the keys. Therefore, by adjusting the height of the hammer return spring rail 110, the resistance and the change in resistance of the keys can be modified. In embodiments, the end blocks 210 are releasably connectable to the other rail blocks 175 in the same manner that said rail blocks 175 are connectable to each other (preferably, as shown in FIG. 21, by having a hexagonally-shaped cross section for receiving a connecting rod 190 with a hexagonally-shaped cross section).

In a preferred embodiment, the dimensions and proportions of each rail block 175 are approximately as indicated in FIGS. 20-23. However, the skilled person would understand that different dimensions and proportions may be preferable for different needs (e.g. a differently-sized piano).

In embodiments, in addition to the advantages previously discussed, the modular hammer return spring rail 110 of the present invention may present one or more of the following advantages:

The length of the modular hammer return spring rail 110, as well as the distance between each hammer return spring, can be easily assembled, customized, adjusted, and/or disassembled, according to the needs of the assembler. It can even be assembled “on site” (where the rest of the piano is already installed).

The modular hammer return spring rail 110 can be installed in conventional upright pianos, meaning they can be used to replace conventional hammer return spring rails.

The modular hammer return spring rail 110 may be easy, cheap, and/or simple to manufacture, as each rail block can be manufactured separately, as opposed to having to manufacture an entire hammer return spring rail of specific length and with specific distances between springs.

By combining the technology of the hammer return spring rail of the previous section with the technology of the modular hammer return spring rail of the present section, a hammer return spring rail comprising the advantages of both technologies can be achieved.

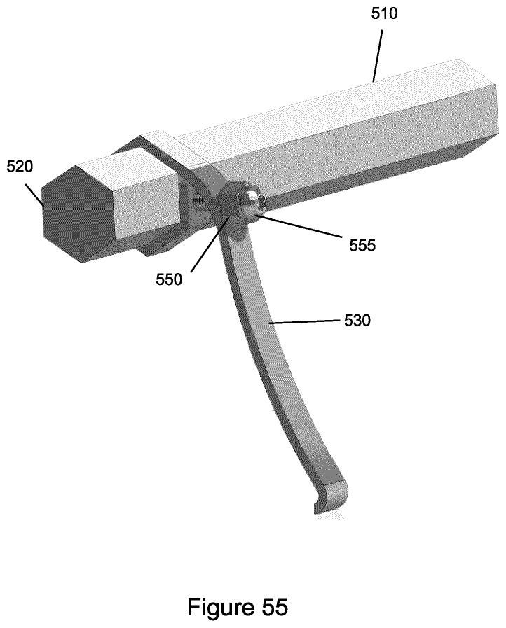

In another embodiment, a hammer return spring rail 510 is shown in FIG. 55. The hammer return leaf spring rail 510 is made of four distinct parts, which are: a rail that may be a hexagonal rod 520, a leaf spring 530, a lock nut 550, and a screw 555.

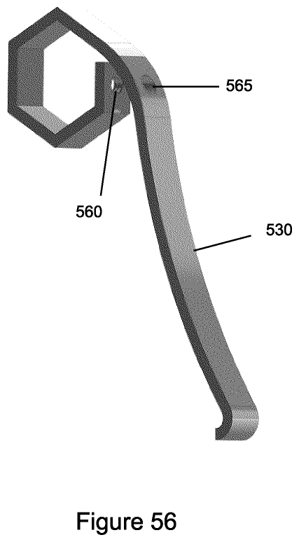

Referring now to FIG. 56, in addition to FIG. 55, the leaf spring 530 has a first section with a threaded passage 560 and another section with a passage 565 for the screw 555. The first section of the leaf spring 530 is shaped as a hexagon for receiving the hexagonal rod 520. The threaded passage 560 and passage 565 are configured to be aligned with each other so as to receive the screw 555.

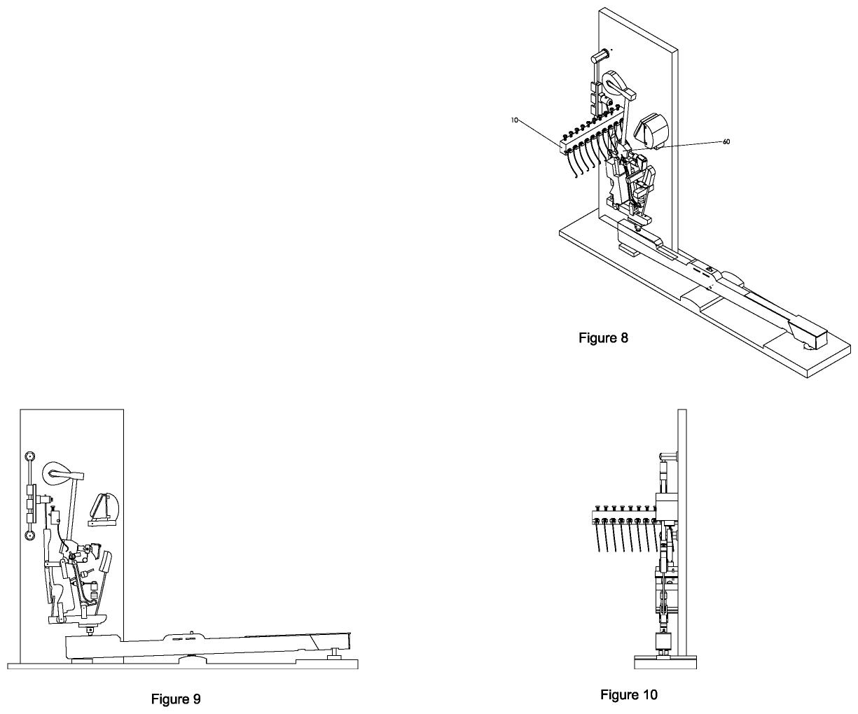

The hammer return spring rail 510 works as follows: the leaf springs 530 slide along the bar or rod 520 to their respectful position in relation to the piano action (Aligned with the center of each hammer butt of each note). The lower part of the leaf spring 530 pushes the hammer butt 60 the same way as the return spring 30, which were described above with respect to FIG. 3-12. The tension of the leaf spring 530 is adjusted by screwing the lock nut 550 which tightens the leaf spring 530 against the rail then the tension diminishes. In the opposite direction, which is loosening the lock nut 550, this unfolds the leaf spring 530 and raises the tension of it against the hammer butt 60. An Allen™ key and a wrench may be used to do the adjustment. The Allen™ key is used to lock the screw 555 in its position in case the lock nut 550 has to be loosened. The wrench is used to rotate the lock nut 550. The Allen key and the screw 555 could be any type of fastener (e.g. Philips™, square, hex, etc.) Tightening the screw 555 locks the leaf spring 530 in its position. This makes each of the leaf springs 530 modular and adjustable, just like as in other preferred embodiments described herein.

### Repetition Spring Assembly for an Upright Piano

In another aspect of the present invention, a repetition spring assembly for an upright piano is provided, comprising: a repetition spring being a torsion spring operatively coupled to a backstop portion of a hammer assembly at a connection point and operatively coupled to a jack end of a jack member, the torsion spring extending therebetween; the backstop portion comprising adjustment means that can adjust the position of the connection point along the backstop portion so as to adjust the tension of the torsion spring.

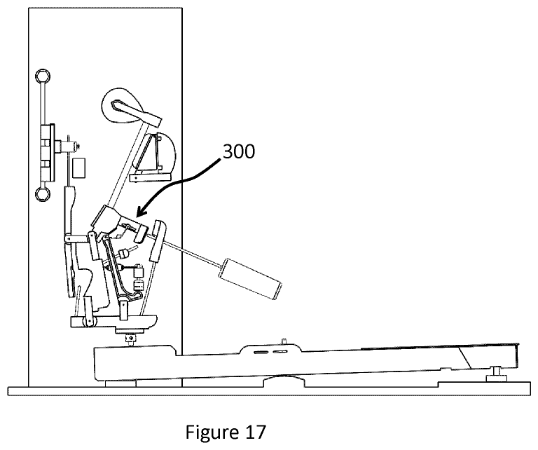

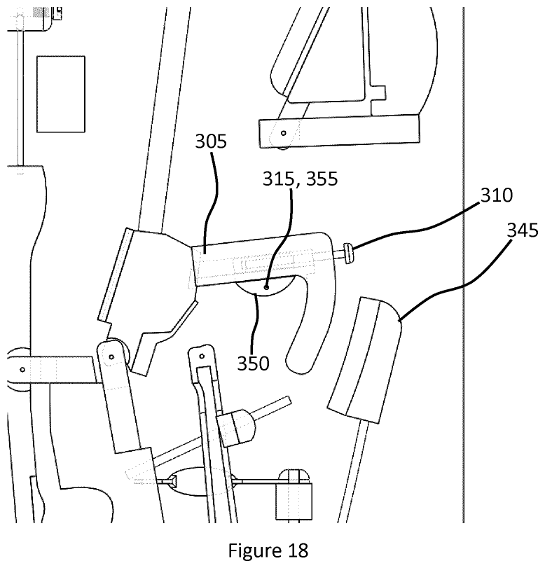

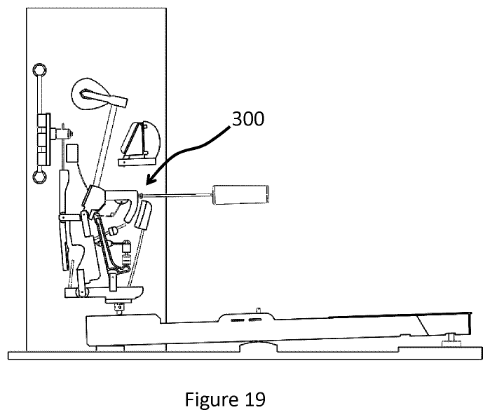

Embodiments of a vertical action comprising the above-defined repetition spring assembly 300 are shown in FIGS. 15-19. Specifically, FIGS. 15-17 show an embodiment comprising a specifically designed backstop portion 305 (also shown in FIGS. 18-19), wherein the adjustment means 310 is a screw. By turning the screw, the connection point 315 at which the torsion spring 320 is connected to the backstop portion can easily be adjusted (by using, for example, an adjustment tool 325, such as a screwdriver), thereby easily adjusting the tension in the torsion spring. In the embodiment shown in FIGS. 15-17, the backstop portion 305 is oriented such that, at certain positions (for example, as shown in FIGS. 25 and 26, when the hammer 330 is resting on the rest rail cloth 335), the adjustment means are accessible using the adjustment tool 325 via an aperture 340 in the back check 345. As shown in FIGS. 15, and 16, the backstop portion 305 can comprise a plate 350 that is connected to the adjustment means 310 and into which the torsion spring 320 can be inserted (through an aperture 355, for example) to connect the torsion spring 320 to the backstop portion 305. In such embodiments, the connection point 315 is located at the aperture 355 in the plate 350. Therefore, by using the adjustment means 310, the plate 350 can be moved along the backstop portion 305, thereby adjusting the tension in the torsion spring 320.

The skilled person would understand that the adjustment means 310 do not have to be a screw, but can be any suitable adjustment means known in the art. In embodiments, the adjustment means is a hand screw that can be turned by hand (and therefore does not require an adjustment tool to be adjusted).

FIGS. 18-19 show a design similar to that shown in FIGS. 15-17; however, the design of the backstop portion 305 (shown in FIGS. 18-19) is different. In FIG. 18-19, the backstop portion 305 is oriented such that, when the hammer 330 is at rest (i.e. the key is not being pressed), the adjustment means 310 is mostly horizontal to the ground and above the back check 345. By having the adjustments means 310 be mostly horizontal to the ground and above the back check 345, the adjustment means 310 can be easily accessed and adjusted using the adjustment tool 325, for example a screwdriver.

In preferred embodiments (not shown), the backstop portion 305 is oriented such that the adjustment means 310 is horizontal to the ground and above the back check 345 when the hammer 330 is resting against the string 360 (i.e. when the key is being pressed), as this would allow for adjustments to be easily made to the tension of the torsion spring 320 while holding the key down.

In more preferred embodiments (not shown), the backstop portion 305 is oriented such that the adjustment means 310 is just above the back check 345, such that the adjustment tool 325 (such as a screwdriver) can rest atop the back check 345 while it is being used to adjust the tension in the torsion spring 320. In even more preferred embodiments, the top of the back check 345 comprises a groove (not shown) dimensioned to receive the adjustment tool 325, which can help secure the position of the adjustment tool 325 while it is resting on the back check 345. This will further improve the ease of adjustment of the tension of the torsion spring 320.

While conventional vertical actions have had adjustable repetition springs, said vertical actions always used compression or leaf springs combined with adjustment screws, which did not allow for accurate and effective adjustment of the repetition spring. Furthermore, the compression spring did not make for an effective repetition spring. In addition, while torsion springs have been used as repetition springs, conventional assemblies comprising torsion springs have not been easily adjustable using adjustment means; rather, they needed to be adjusted directly by hand (using fingers, plyers, etc.).

With the repetition spring assembly of the present invention, the backstop portion 305 allows for easy and precise adjustments to be made of the tension in the repetition spring 320 (which is a torsion spring). In embodiments, every millimeter of adjustment made using the adjustment means 310 can add or remove about 10 grams of force.

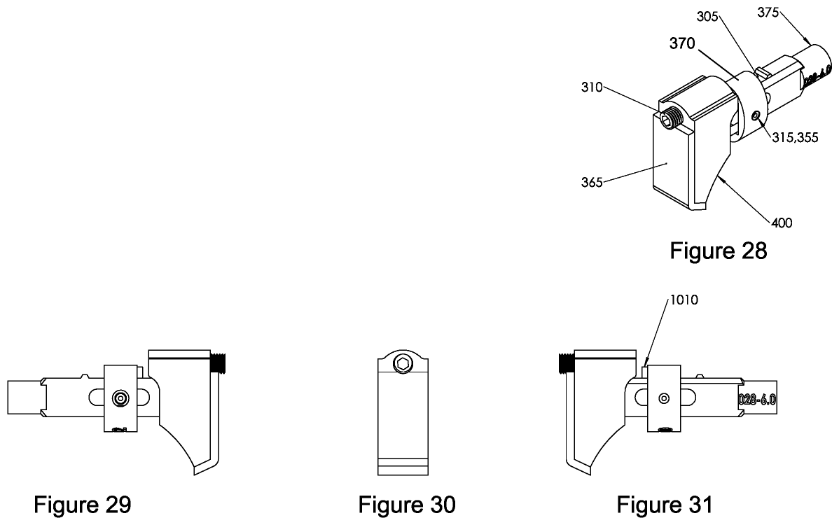

A preferred embodiment of the backstop portion 305 is shown in FIGS. 28-31.

As also shown in FIG. 28, in preferred embodiments, the backstop portion 305 comprises a catcher portion 365, a ring portion 370, and a shank portion 375. The catcher portion 365 is operatively connected to the shank portion 375, while the ring portion 370 is connected to the shank portion 375 in such a manner that it is movable along the length thereof, and the connection point 315 is located on the ring portion 370. In preferred embodiments, and as shown in FIG. 28, the adjustment means 310 is a screw located at an upper portion of the catcher portion 365 of the backstop portion 305. By turning the screw 310, the screw pushes the ring portion 370 (preferably an upper portion of the ring portion 370, as shown in FIG. 28), thereby moving said ring portion 370 along a length of the shank portion 375. By doing this, the connection point 315 at which the torsion spring 320 is connected to the backstop portion 305 can easily be adjusted (by using a screwdriver, preferably), thereby easily adjusting the tension in the torsion spring 320. In embodiments, while the adjustment means 310 positions the ring portion 370 along the shaft, the tension in the torsion spring 320, as well as the centrifugal force that occurs when the key is pressed and the repetition spring assembly is in motion, also help keep the ring portion 370 in its position.

As mentioned, the ring portion 370 is configured to be pushed forward along a length of the shank portion 375 using the adjustment means 310. In embodiments, the ring portion 370 is configured to be moved backwards along a length of the shank portion 375 also by using the adjustment means 310 and the tension in the torsion spring 320, which pushes the ring portion 370 against the adjustment means 310. Accordingly, as the adjustment means 310 is moved backwards, the tension in the torsion spring 320 pushes the ring portion 370 backwards against the adjustment means 310. Alternatively, as the adjustment means 310 is moved backwards, the user can push the ring portion 370 backwards until it is against the adjustment means 310 (this would be preferable in configurations where, for example, there is sufficient tension in the torsion spring 320 to hold the ring portion 370 against the adjustment means 310, but not enough tension to move the ring portion 370 backwards when the adjustments means 310 is moved back).

As shown in FIG. 28, in preferred embodiments, the surface on which the connection point 315 is located is curved. By having a curved surface surrounding the connection point 315 (specifically the region directly below the connection point 315), the amount of surface area that can potentially abut the torsion spring 320 is reduced, thereby reducing unwanted friction between the torsion spring 320 and the backstop portion 305. In general, the more curved the area around the aperture, the more the contact (and friction) between the torsion spring 320 and the backstop portion 305 is reduced. For clarity, in such a configuration, the connection point 315 represents the “outer most” surface of the corresponding side of the backstop portion 305.

A variety of physical shapes can be used to reduce the friction between the torsion spring 320 and the backstop portion 305; what matters is that the area of contact between the torsion spring 320 and the backstop portion 305 is lowered as much as possible. In theory, the area around the connection point does not even need to be “curved”: it can just be a slanted surface. For example, the backstop portion 305 can comprise a protrusion in the shape of a cone or a four-sided pyramid, with the connection point 315 being located at the tip of said cone or four-sided pyramid.

In preferred embodiments, for example as shown in FIG. 28, the backstop portion 305 has an opening 405 (preferably conical in shape) opposite the connection point 315 for insertion of a bushing. In preferred embodiments, this bushing is what allows the torsion spring to be connected to the connection point 315.

The opening 405 is preferably between about 3 mm and about 2 mm in diameter in order to allow for passage of a tool, preferably a press cylinder, used to insert the bushing into the backstop portion 305. While the opening 405 can have different dimensions, it should be dimensioned to allow for entry of the tool, which should have a sufficient diameter to allow for insertion of the bushing (for example, the embodiment shown in FIG. 28 is dimensioned for a bushing with an outer diameter of 1.8 mm). The bushing may comprise different dimensions, as long as it fits the torsion spring 320 and does not produce a noise while the assembly is being used. Similarly, the connection point 315 is dimensioned such that the bushing cannot pass therethrough. Accordingly, by connecting the bushing to the torsion spring 315, the bushing is rendered secure and the torsion spring is connected to the backstop portion 305 at the connection point 315.

The catcher portion 365, as shown in FIG. 28, can have a recess (or an aperture) dimensioned to receive a corresponding protrusion from the shank portion 375.

The catcher portion 365, as shown in FIG. 28, can further comprise a curved portion 400 on the bottom surface thereof in order to prevent the repetition from hitting it when the spring is under its maximum tension. Preferably, the shape and dimensions of the curved portion 400 are chosen so as to resemble the tail of the grand piano hammer.

The skilled person would understand that the ring portion 370 can be many different shapes (for example, the ring portion 370 can be in the shape of an unclosed ring, or even in the shape of a plate 350 as defined above), so long as it is dimensioned to be slidably movable along the length of the shank portion 375 when the adjustment means 310 (preferably a screw) is adjusted, while also, in preferred embodiments, being dimensioned (e.g. sufficiently curved) to reduce the area of contact between the torsion spring 320 and the backstop portion 305. In a preferred embodiment, the ring portion 370 comprises an aperture 385 dimensioned to slidably receive a corresponding protrusion from the shank portion 375.

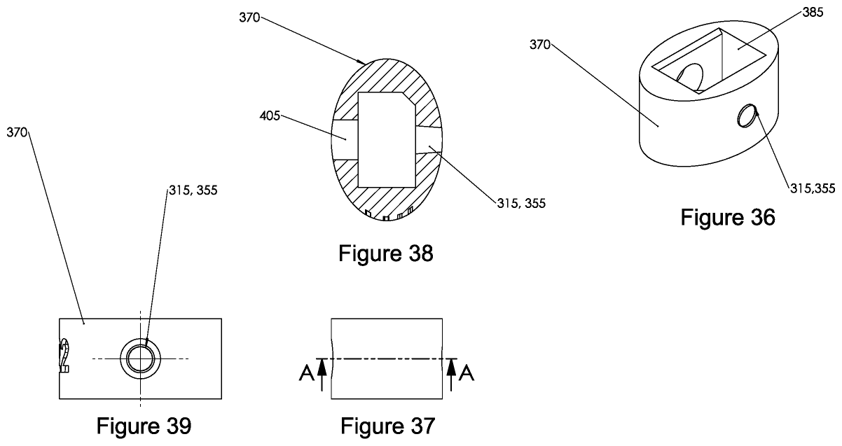

In a preferred embodiment, and as shown in FIGS. 36-39, the ring portion 370 has an ellipse-shaped cross section. In a more preferred embodiment, such as that shown in FIG. 38, the minor axis is horizontal with the ground and is around the width of the jack end of the jack member. With respect to a vertical axis passing through the connection point 315, it is preferable that the angle of the line tangent to the curvature of the ring portion 370 (or rather the angle of the line tangent to the area of the backstop portion directly underneath the connection point 315) with respect to said vertical axis is greater, preferably excessively greater, than the angle at which the torsion spring 320 (or any connector that connects the torsion spring 320 to the connection point 315) approaches said connection point 315. This will help minimize the level of contact between the torsion spring 320 and the backstop portion 305.

In preferred embodiments, the connection point 315 is located on a side of the ring portion 370, as shown for example in FIG. 28. In a more preferred embodiment, the opening 405 is located opposite the connection point 315 on the ring portion 370, as shown for example in FIG. 38.

In embodiments, the ring portion 370 is sufficiently secured to the shank portion 375 so as to prevent unwanted sliding or movement (e.g. wiggling) of the ring portion 370 along the shank portion 375. This will prevent unwanted noise from the ring portion 370 during use. The ring portion 370 can be secured in place using the tension of the torsion spring 320. Specifically, when the torsion spring 320 is connected to the ring portion 370, the tension of the torsion spring 320 holds the ring portion 370 in place. Preferably, the ring portion 370 is sufficiently secure such that a reasonable amount of force (supplied by turning the screw) is needed to slide the ring portion 370 along the shank portion 375.

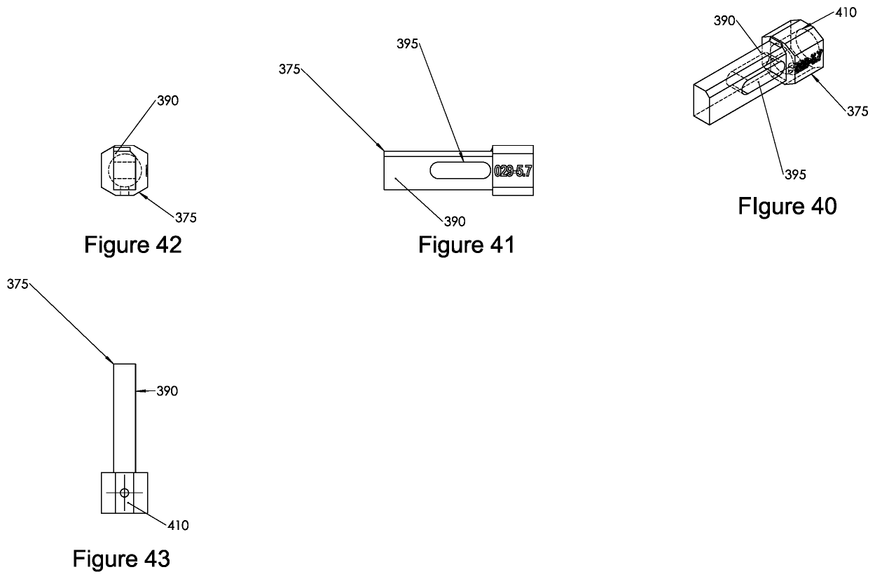

The shank portion 375, as shown in FIGS. 40-43, can have a protrusion 390 dimensioned to be slidably received by the aperture 385 of the ring portion 370 and recess 380 of the catcher portion 365. In preferred embodiments, and as shown in FIG. 40, the protrusion 390 may define an aperture 395. This aperture prevents unwanted contact (and friction) between the torsion spring 320 (or any parts that operatively connect the torsion spring 320 to the connection point 315, such as a bushing) and the shank portion 375. In such configurations, the ring portion 370 is also better secured to the shank portion 375.

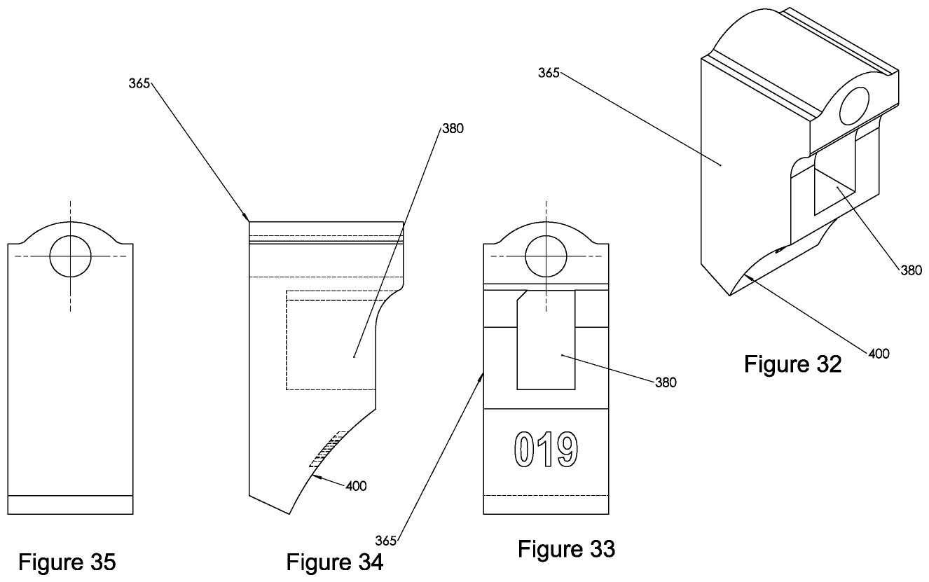

In a more preferred embodiment, the dimensions and proportions of each component of the backstop portion 305 are approximately as indicated in FIGS. 28-43. However, the skilled person would understand that different dimensions and proportions may be preferable for different needs (e.g. a differently-sized piano).

The backstop portion 305 can me manufactured in a variety of ways, as would be understood by the person of skill in the art, and with a variety of materials, such as with PETG, ABS, PLA, NYLON, PC, Carbon fiber, Kevlar, Wood, polymers, brass, and aluminum. In more preferred embodiments, the backstop portion 305, including each of the catcher portion 365, the ring portion 370, and/or the shank portion 375, are made of glass fiber nylon. In alternate embodiments, the catcher portion 365 and the shank portion 375 can be one integral part.

It is worth noting that the backstop portion 305 shown in FIG. 28 is configured such that the ring portion 370 moves along the shank portion 375 in a straight line. However, alternatively, the backstop portion 305 can be configured such that the ring portion 370 moves along the shank portion 375 in a curved line (for example, by having the protrusion 390 be curved), which would maximize the angle at which the torsion spring 320 is working in conjunction with the repetition jack. Such curves would allow the torsion spring 320 to push in its exact orientation and would reduce the constraint placed thereon. In addition, as shown for example in FIG. 78, the backstop portion 305 can be configured such that the ring portion 370 moves at an angle with respect to the rest of the shank portion 375.

In embodiments, the backstop portion 305 shown in FIG. 28 can easily be retrofitted into conventional vertical action pianos. In general, it is preferable that the shank portion 375 comprise a female connector 410 if the backstop portion 305 is to be retrofitted into conventional upright pianos, as many conventional upright pianos with conventional shanks already installed therein are most easily adapted to receive the backstop portion 305 of the present invention by simply cutting the already-installed conventional shank into the shape of a “male connector” dimensioned to be received by the female connector 410 of the backstop portion 305 of the present invention. However, the backstop portion 305 can be installed in a conventional upright piano using any known means in the art.

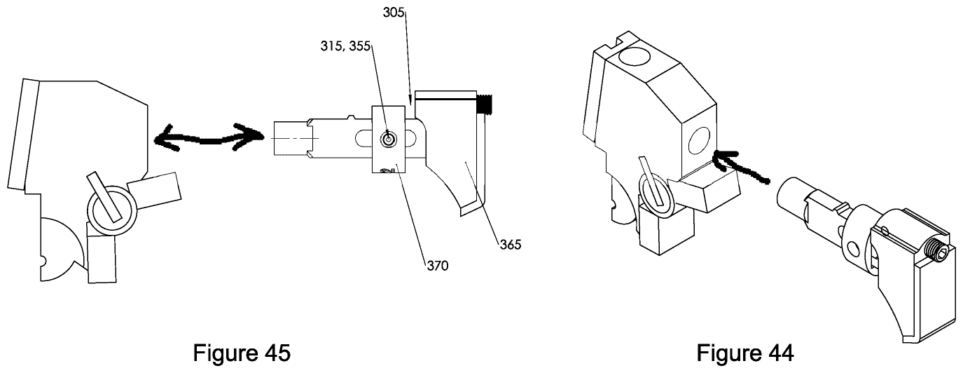

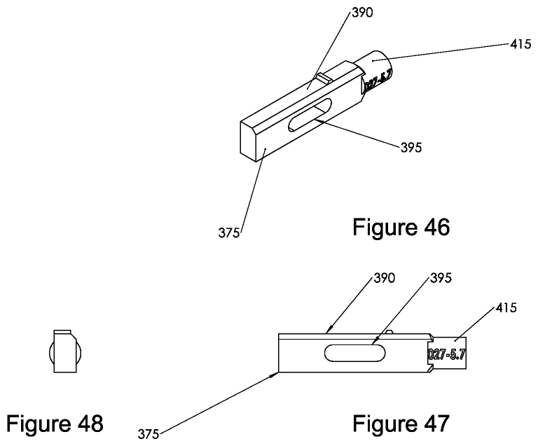

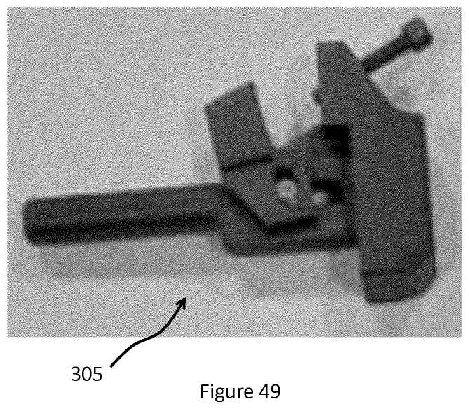

Similarly, conventional hammer butts of conventional upright pianos typically comprise female connectors configured to receive corresponding male connectors of conventional shanks (said shanks being installed during construction of the upright piano). Accordingly, in alternative embodiments, and as shown in FIGS. 44-45, the shank portion 375 can comprise a male connector 415 dimensioned to allow the backstop portion 305 to be connectable to said female connector of said conventional hammer butt of a conventional upright piano during construction thereof. With such a configuration, the backstop portion 305 of the present invention can be easily installed into an otherwise conventional upright piano during construction thereof (as opposed to being retrofitted into an already constructed upright piano with a conventional shank already installed therein). However, the backstop portion 305 can be operatively coupled to the hammer butt using any known means in the art.

### Pedal Assembly for Upright Piano

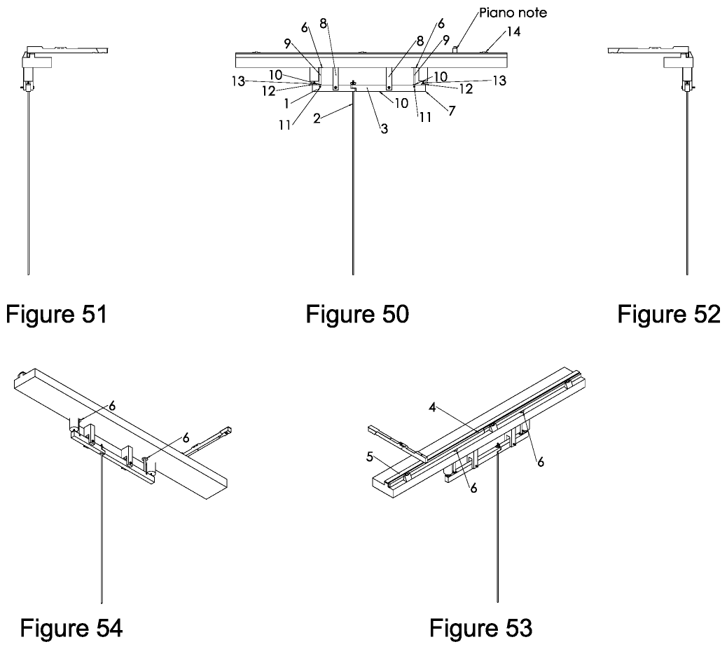

A pedal assembly for an upright piano is also provided. Said pedal assembly is preferably configured for use with the repetition spring assembly 300 and the hammer return spring rail 10 of the present invention (as described in the previous sections) or with the Fandrich Vertical Action. Pictures of an upright piano comprising an embodiment of the pedal assembly of the present invention are shown in FIGS. 50-54. Instead of having a rotating bar hinged on the piano (as is the case with conventional Fandrich Vertical Actions), said pedal assembly comprises a free floating bar 4 configured to lift a back end of the piano keys; this lowers the front end of the piano keys, which results in a lowered keyboard for the pianist. This in turn causes the hammers to move closer to the strings, thereby resulting in softer notes for the player. The free floating bar 4, being free, goes back down due to gravity, preferably only gravity, when the pedal is released. Typically, when pushing against the back end of the keyboard and, therefore, against the piano action mechanism, the weight felt at the pedal for the pianist is ideal, but the return of the keys when the pedal is released can be noisy. To improve this, in preferred embodiments, felt can be installed on the free floating bar 4.

The free floating bar 4 is lifted by a double lever mechanism pulled by the soft pedal of the piano, as will be defined below and as shown in FIG. 53. This raises the back end of the piano keys, preferably by 3 to 5 millimeters, depending on the dimensions of the piano, which depresses the front keyboard, preferably by roughly 50%, such that the hammers are brought closer to the strings by a corresponding amount (preferably approximately 15 to 25 mm closer to the strings, depending on the size of the piano and the preferences of the user). In general, the free floating bar 4 lifts the back end of the piano keys to a sufficient degree to cause the keyboard to be sufficiently dropped (depressed) and the hammers to be brought sufficiently closer to the strings such that the notes are sufficiently “softened” according to the needs of the user.

It should be mentioned that the above-described pedal assembly could result in asynchronous movement of the different sections of keys of the piano while pressing the pedal. This means that the free floating bar 4 could be raised unevenly (i.e. it slopes to the left or to the right). This could be due to, among other things, the change of the body of the piano, the accuracy of the built part, and the height of the keys. This causes some of the back ends of the keys to be raised earlier, and raised further, than others. Conversely, if the bar 4 is raised evenly, it can push all keys evenly, and simultaneously. To ensure that the bar is raised evenly, and as shown for example in FIG. 53, if the user so desires, the pedal assembly of the present invention can include an adjustment means 10′ (e.g. a screw type capstan) for adjusting the height of pushing rods 9 configured to lift the free floating bar 4 when the pedal is pressed. This can be used to make the lifting of the back ends of the piano keys (they have different weights and inertia, the bass section being vastly heavier) synchronous or asynchronous, if desired. In embodiments, the raising of the free floating bar 4 can be limited by a limiter 13 on the double lever mechanism and can be adjusted in a way that allows the piano to have a softer or less soft pedal. This increases or decreases the amount the back ends of the keys are lifted by limiting how much the free floating bar 4 can be lifted from its resting position.

In preferred embodiments, the free floating bar 4 simply rests on the pushing rods 9 when it is lifted (i.e. it is not secured to the pushing rods 9), such that when the pedal is released, the free floating bar 4 goes back down due to gravity only (as mentioned previously). In alternative embodiments, the free floating bar 4 is loosely connected to the pushing rods 9, such that the free floating bar 4 is pulled downward by gravity and the weight of the mechanism of the piano when the pedal is released. Also, while it is preferable that the free floating bar 4 not be attached to any part of the piano, in alternative embodiments, the free floating bar 4 is loosely connected to a part of the piano (for example, the key resting rail) to help ensure a straight up-and-down movement of the bar; this can also be done using a track limiter, defined in more detail below.

FIGS. 50-54 show an embodiment of the pedal assembly of the present invention installed in a vertical action, and comprising the following:

1. a left lever

2. a pedal rod operatively connected to an end of the left lever 1 and right lever 3.

3. a right lever

4. a free floating lifting bar: felt that helps cancel the noise from hitting the keys can be seen in FIG. 54.

5. a key resting rail with felt placed thereon

6. A bushing with red felt inside

7. A right assembly (including the right lever 3, which is longer than the left lever, being configured as such because the center of rotation of the lever and the alignment of center of mass of the mechanism is to the left of the center of the piano)

8. A lever base and center of rotation for each of the left lever 1 and right lever 3: each lever (both left and right) has one, and they are independent of each other.

9. A free bar pushing rod, one located on the left lever 1 and another located on the right lever 3, on an end opposite to where the pedal rod 2 is connected;

10′. An adjustment means: this is a vertical adjustment means (in this case, a capstan, specifically a screw type capstan): by rotating the capstan, the height of each pushing rod can be adjusted; if the height of a specific pushing rod is increased, said pushing rod will lift the free floating bar further. This allows the pedal assembly to be adjustable in a precise manner and guarantees its ability to synchronize the lifting position of the left and right side when the soft pedal is pressed.

11. An aperture that allows a tool to rotate the capstan which results in a change of length (or rather height) of the pushing rod 9.

12. A stopper to limit the course (the degree of rotation) of the levers: this way the pedal can be made “softer” or “louder”. Limiting the course of the levers will get the hammers further from or closer to the strings depending on the volume, tone and quality desired for the piano.

13. A capstan screw that stops the lever from going further upward. The stopper 12 can be aligned with it on the lever to suppress the knocking sound a piano may normally make every time the pedal is pressed. In embodiments, the stopper and/or the capstan screw can be placed on the left lever 1, the right lever 3 (as shown in FIG. 50), or both.

14. A track limiter (the pedal assembly pictured actually comprises 3 of them). They are used to help ensure a straight up-and-down movement of the bar and to block it from rotating freely. They can also have dampers on them (noise cancellers) to help ensure that lifting the bar does not create noise due to friction, which is not desired in a piano.

As mentioned, the amount the free floating bar 4 is lifted is such that the back ends of the keys are lifted preferably between about 3 mm and about 7 mm depending on the size of the piano and the desires of the user.

In order to lift the free floating bar 4, pressing the pedal pulls the pedal rod 2 downwards, which pulls one end of each of the left lever 1 and right lever 3 downward, which forces them to rotate around each of their respective centers of rotation 8. This rotation pushes the pushing rods 9 upwards, which in turn lift the free floating bar 4. It is worth noting that the levers 1 3 can have conical holes to receive the pedal rod 2, as shown for example in FIG. 50, which makes it possible for them to rotate around the pedal rod 2.

In embodiments, such as that shown in FIG. 80, the pedal assembly of the present invention comprises a bushing with red felt 6 for each pushing rod 9. Said bushings serve as a “loose” guide and can comprise red felt of a length that covers the section of the rods that would be in contact with the body of the piano. This part also serves as a noise canceller. It is worth noting that, when the pedal is pushed, the levers 1 and 3 are actually rotated, meaning the pushing rods 9, while they mostly experience vertical displacement (they are pushed “upwards”), also experience some horizontal displacement and a change in angle.

To take this horizontal displacement and change in angle into account, the bushing 6 is preferably dimensioned so that it only loosely receives its corresponding pushing rod 9, meaning the bushing 6 dimensions are big enough compared to the pushing rod 9 such that it affords the pushing rod 9 some freedom of movement, but is still able to guide the pushing rod 9 upward.

Also, in embodiments, the free floating bar 4 can be placed behind the key resting rail or in front of it, preferably in front of it as shown in FIG. 53.

In preferred embodiments, and as shown in FIG. 53, the floating bar can be covered in vinyl (thermoplastic), both to seal the bar (which is preferably made of steel, although any suitable material can be used, as would be understood by the person of skill in the art) and to help safely keep the lifting of the back ends of the piano keys even. In preferred embodiments, the top surface of the free floating bar can be made uneven in height in order to take into account any unevenness in the heights of the back ends of the keys (which can occur naturally in upright pianos after extended periods of use). For example, if the back end of a specific key is raised slightly more than those adjacent to it, it is possible to dimension the free floating bar 4 such that the surface directly under that misaligned key is slightly higher. This further ensures that the keys are pushed evenly and at the same time. Although not visible in the photo, in the embodiment shown in FIG. 53, a material was added under the vinyl wrap to “level the bar” with the piano keys as just described.

The scope of the claims should not be limited by the preferred embodiments set forth in the examples, but should be given the broadest interpretation consistent with the description as a whole.

### DEFINITIONS

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

1-26. (canceled)

27. A repetition spring assembly for an upright piano comprising:
a repetition spring being a torsion spring operatively coupled to a backstop portion of a hammer assembly at a connection point and operatively coupled to a jack end of a jack member, the torsion spring extending therebetween;
the backstop portion comprising adjustment means that can adjust the position of the connection point along the backstop portion so as to adjust the tension of the torsion spring.

28. The repetition spring assembly of claim 27, wherein the backstop portion comprises a plate that is connected to the adjustment means and into which the torsion spring can be inserted, through an aperture, to connect the torsion spring to the backstop portion.

29. The repetition spring assembly of claim 27, wherein the backstop portion is oriented such that, when the hammer is at rest, the adjustment means is mostly horizontal to the ground and above a back check.

30. The repetition spring assembly of claim 27, wherein the backstop portion is oriented such that the adjustment means is mostly horizontal to the ground and above the back check when a corresponding hammer is resting against a corresponding string.

31. The repetition spring assembly of claim 27, wherein the backstop portion is oriented such that the adjustment means is just above the back check, such that an adjustment tool can rest atop the back check while it is being used to adjust the tension in the torsion spring.

32. The repetition spring assembly of claim 31, wherein the top of the back check comprises a groove dimensioned to receive the adjustment tool.

33. The repetition spring assembly of claim 27, wherein at least a surface of the backstop portion directly below where the connection point is located is curved or slanted so as to reduce contact and friction between the torsion spring and the backstop portion.

34. The repetition spring assembly of claim 27, wherein the backstop portion has an opening opposite the connection point for insertion of a bushing.

35. The repetition spring assembly of claim 27, wherein the backstop portion comprises a catcher portion, a ring portion, and a shank portion, wherein the catcher portion is operatively connected to the shank portion, the ring portion is connected to the shank portion in such a manner that it is movable along the length thereof, and the connection point is located on the ring portion.

36. The repetition spring assembly of claim 35, wherein the adjustment means is located at an upper portion of the catcher portion of the backstop portion, such that by turning the adjustment means, the a screw pushes the ring portion, thereby moving said ring portion along a length of the shank portion.

37. The repetition spring assembly of claim 35, wherein the catcher portion has a recess (or an aperture) dimensioned to receive a corresponding protrusion from the shank portion.

38. The repetition spring assembly of claim 35, wherein the catcher portion further comprises a curved portion on the bottom surface thereof in order to prevent the repetition from hitting it when the torsion spring is under its maximum tension.

39. The repetition spring assembly of claim 35, wherein the ring portion comprises an aperture dimensioned to slidably receive a corresponding protrusion from the shank portion.

40. The repetition spring assembly of claim 35, wherein the ring portion has an ellipse-shaped cross section.

41. The repetition spring assembly of claim 40, wherein the minor axis of the ellipse-shaped cross section is horizontal with the ground and is around the width of the jack end of the jack member.

42. The repetition spring assembly of claim 35, wherein, with respect to a vertical axis passing through the connection point, the angle of the line tangent to the curvature of the ring portion, (or the angle of the line tangent to the area of the backstop portion directly underneath the connection point with respect to said vertical axis is greater than the angle at which the torsion spring or any connector that connects the torsion spring to the connection point approaches said connection point.

43. The repetition spring assembly of claim 35, wherein the ring portion is configured to be sufficiently secured to the shank portion using the tension of the torsion spring and the friction of the interaction between the ring portion and the shank portion.

44. (canceled)

45. (canceled)

46. The repetition spring assembly of claim 35, wherein the shank portion comprises a protrusion dimensioned to be slidably received by the aperture of the ring portion and recess of the catcher portion.

47. (canceled)

48. (canceled)

49. The repetition spring assembly of claim 35, wherein the shank portion further comprises a female connector configured to receive a corresponding male connector of a corresponding hammer butt.

50. The repetition spring assembly of claim 35, wherein the shank portion further comprises a male connector configured to be received by a female connector of a corresponding hammer butt.

51-61. (cancelled)
